(19) United States
(12) Patent Application Publication
(10) Pub. No.: US 2024/0169202 A1
(43) Pub. Date: May 23, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: HIDEKI SORAKADO, Tokyo (JP)

(21) Appl. No.: 18/509,119

(22) Filed: Nov. 14, 2023

(30) Foreign Application Priority Data
Nov. 17, 2022 (JP) 2022-184280

(51) Int. Cl. G06N 3/08

(52) U.S. Cl. CPC G06N 3/08

(57) ABSTRACT

An information processing apparatus performing inference or learning using a neural network generates an attention map from input data, performs a nonlinear transformation on the input data, obtains, based on the generated attention map and an output obtained based on the nonlinear transformation on the input data, a feature amount map having a channel dimension for storing an element vector and one or more spatial dimensions, and performs an inference or learning process based on the obtained feature amount map.

### BACKGROUND

### Field

The present disclosure relates to an information processing apparatus, an information processing method, and a storage medium.

### Description of the Related Art

Japanese Unexamined Patent Application Publication (Translation of PCT Application) No. 2020-506466 discloses a neural network with a self-attention mechanism that determines a position-by-position relationship of an input sequence and transforms the input sequence based on the relationship. Alexey Dosovitskiy, et al. An image is worth 16×16 words: Transformers for image recognition at scale. In International Conference on Learning Representations, 2021, discloses a neural network that performs image classification by the self-attention mechanism by dividing an image into patches or the like to form a sequence. Further, Jie Hu, Li Shen, and Gang Sun. Squeeze-and-excitation networks. CVPR, 2018. discloses a neural network having a mechanism for obtaining an attention map from input data and performing attention by a product of elements of the input data and the attention map.

However, in the related art, attention is directly applied to the data used to generate the attention. Therefore, when the data to which the attention is applied includes an unnecessary feature, the unnecessary feature is also emphasized, and the accuracy of processing of the neural network may be reduced.

### SUMMARY OF THE INVENTION

According to an aspect of the present disclosure, an information processing apparatus performing inference or learning using a neural network includes one or more processors, and one or more memories that store a computer-readable instruction that, when executed by the one or more processors, configures the information processing apparatus to generate an attention map from input data, perform a nonlinear transformation on the input data, obtain, based on the generated attention map and an output obtained based on the nonlinear transformation on the input data, a feature amount map having a channel dimension for storing an element vector and one or more spatial dimensions, and perform an inference or learning process based on the obtained feature amount map.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an information processing apparatus according to an exemplary embodiment.

FIGS. 2A, 2B, and 2C are diagrams illustrating examples of a functional configuration of the information processing apparatus according to the present exemplary embodiment.

FIGS. 3A, 3B, 3C, and 3D are diagrams illustrating a neural network according to the present exemplary embodiment.

FIGS. 4A and 4B are diagrams illustrating a neural network according to the present exemplary embodiment.

FIGS. 5A and 5B are diagrams illustrating a neural network according to the present exemplary embodiment.

FIGS. 6A and 6B are diagrams illustrating a neural network according to the present exemplary embodiment.

FIG. 7 is a flowchart for explaining a procedure of processing executed by the information processing apparatus.

### DESCRIPTION OF THE EMBODIMENTS

Hereinafter, exemplary embodiments of the present disclosure will be described with reference to the drawings.

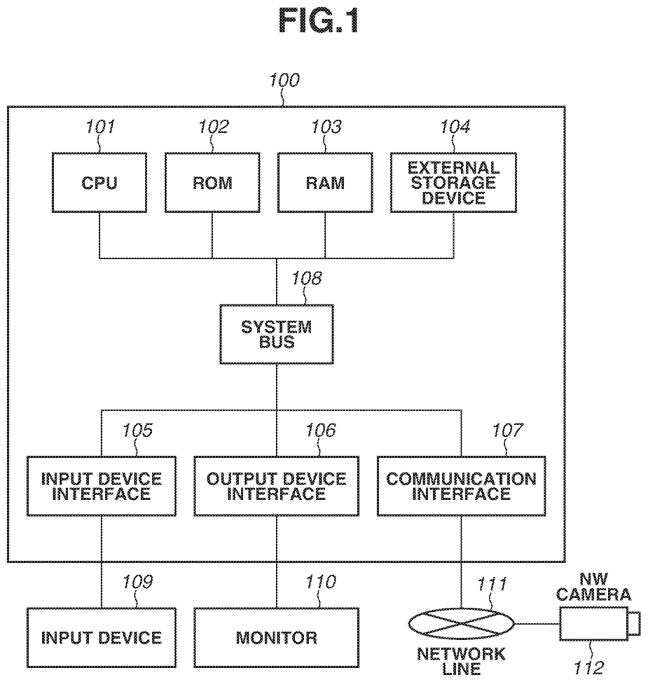

FIG. 1 is a block diagram illustrating a hardware configuration example of an information processing apparatus according to an exemplary embodiment. The information processing apparatus according to the present exemplary embodiment is an information processing apparatus that performs inference or learning using a neural network. An information processing apparatus 100 includes a central processing unit (CPU) 101, a read-only memory (ROM) 102, a random access memory (RAM) 103, an external storage device 104, an input device interface 105, an output device interface 106, a communication interface 107, and a system bus 108.

The CPU 101 controls the entire information processing apparatus 100. The ROM 102 is a memory for storing programs and parameters that do not need to be changed. The RAM 103 is a memory for temporarily storing programs and data supplied from an external device or the like. The external storage device 104 is a storage device, such as a hard disk or a memory card, fixedly installed in the information processing apparatus 100. The external storage device 104 may include an optical disk, such as a flexible disk (FD) or a compact disk (CD), a magnetic or optical card, an integrated circuit (IC) card, a memory card, or the like that is detachable from the information processing apparatus 100.

The input device interface 105 is an interface with an input device 109, such as a pointing device or a keyboard, that receives a user operation and via which data is input.

The output device interface 106 is an interface with a monitor 110 for displaying data held by the information processing apparatus 100 and data supplied thereto. The communication interface 107 is a communication interface for connecting to a network line 111, such as the Internet. For example, the information processing apparatus 100 is connected to a NW camera 112 via the network line 111. The NW camera 112 is an image capturing apparatus that captures video. The system bus 108 is a bus that communicably connects the functional units 101 to 107 included in the information processing apparatus 100. Each process described below functions as a process when the CPU 101 executes a program stored in a computer-readable storage medium, such as the ROM 102.

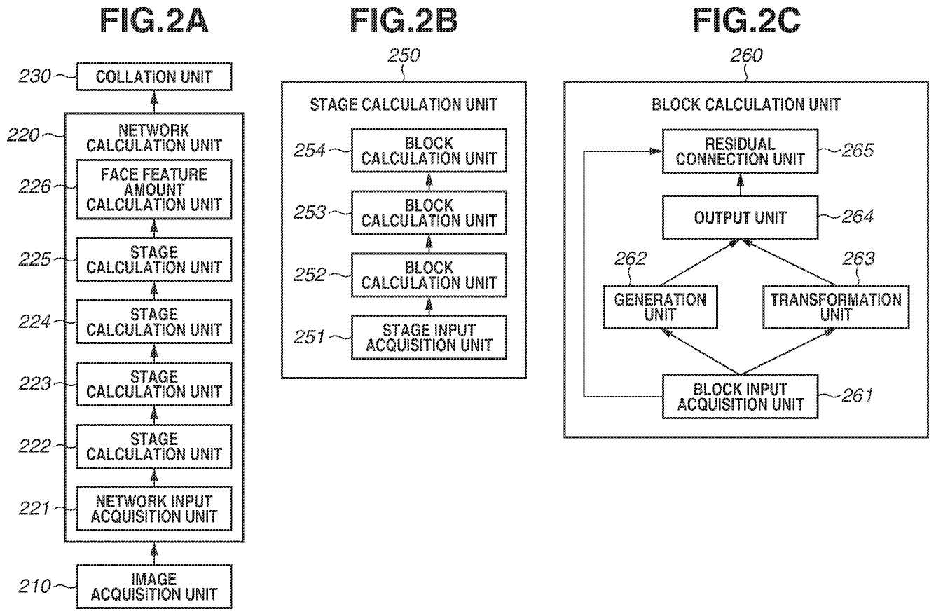

FIGS. 2A, 2B, and 2C are block diagrams illustrating functional configuration examples of the information processing apparatus according to the present exemplary embodiment. FIGS. 2A to 2C illustrate functional configuration examples of the information processing apparatus that performs a face authentication task of determining whether a face in each of two images is the face of the same person, as the functional configuration examples of the information processing apparatus according to the present exemplary embodiment. In executing a task, the information processing apparatus according to the present exemplary embodiment may perform another task including a process of generating attention and outputting output data that is a feature amount map on the basis of the attention.

FIG. 2A is the diagram illustrating a configuration example of the information processing apparatus according to the present exemplary embodiment. As illustrated in FIG. 2A, the information processing apparatus according to the present exemplary embodiment includes an image acquisition unit 210, a network calculation unit 220, and a collation unit 230.

The image acquisition unit 210 acquires an image in which the face of a person is captured. For example, the image acquisition unit 210 acquires a face image of a person stored in the external storage device 104 or the like. Alternatively, the image acquisition unit 210 may generate a face image by specifying a face region in an image stored in the external storage device 104 or the like by face detection processing or the like.

The network calculation unit 220 processes the face image acquired by the image acquisition unit 210 to generate a feature vector. For example, the network calculation unit 220 reads weights of the neural network stored in the external storage device 104, and generates the feature vector from the face image using the neural network.

The collation unit 230 acquires the feature vector of each of the two face images obtained by the processes performed by the image acquisition unit 210 and the network calculation unit 220, collates the acquired two feature vectors with each other, and determines whether two persons are the same person. In this way, face authentication is performed. Specifically, if a degree of similarity (distance) between the two feature vectors satisfies a predetermined condition, it is determined that the persons in the images indicated by the two feature vectors are the same person. On the other hand, if the degree of similarity (distance) between the two feature vectors does not satisfy the predetermined condition, it is determined that the persons in the images indicated by the two feature vectors are different persons.

The network calculation unit 220 includes a network input acquisition unit 221, four stage calculation units 222, 223, 224, and 225, and a face feature amount calculation unit 226.

The network input acquisition unit 221 acquires data to be input to a first stage (the first stage calculation unit 222). For example, the network input acquisition unit 221 acquires an image as a three-dimensional tensor of height, width, and channel (HWC). The channel is a dimension that stores red, green, and blue (RGB) values of an image. When a plurality of images is collectively processed as one mini batch, the network input acquisition unit 221 may acquire the plurality of images as a four-dimensional tensor of batch size, width, height, and channel (BWHC). Further, an image may be converted by the network input acquisition unit 221. For example, RGB values of each pixel of the image is often between 0 and 255, and the network input acquisition unit 221 may perform conversion for normalizing the RGB values to values between 0 and 1. Further, the network input acquisition unit 221 may perform normalization by batch normalization or the like, or may perform conversion by convolution or the like. The normalization and conversion performed by the network input acquisition unit 221 are not limited thereto.

In the stage calculation units 222 to 225, each of the stage calculation units 222 to 225 processes an output of the network input acquisition unit 221 or the previous stage calculation unit to acquire the feature amount map. For example, the stage calculation unit 223 acquires the feature amount map by performing conversion or the like on the feature amount map output from the stage calculation unit 222 of the previous stage. Although FIG. 2A illustrates an example in which four stage calculation units 222 to 225 are included, the number of stage calculation units included in the network calculation unit 220 may be any number and is not limited to four.

The face feature amount calculation unit 226 converts the feature amount map output from the stage calculation unit 225 into a feature vector for face authentication. For example, the face feature amount calculation unit 226 performs a flattening process (a process of flattening a high-dimensional feature amount map into a one-dimensional vector) on the feature amount map, and then converts the feature amount map into a feature vector by a fully connected layer. Alternatively, the face feature amount calculation unit 226 may convert the feature amount map into a feature vector for face authentication as follows. For example, the two-dimensional tensor output by the stage calculation unit 225 is returned to a three-dimensional tensor of height, width, and channel. Next, GlobalAveragePooling as described in Network in network (M. Lin, Q. Chen, and S. Yan arXiv:1312.4400, 2013) is applied to the feature amount map. Thereafter, the feature vector may be output by the fully connected layer. The conversion method to the feature vector performed by the face feature amount calculation unit 226 is not limited thereto.

FIG. 2B is a diagram illustrating a configuration example of the stage calculation unit illustrated in FIG. 2A. In the present exemplary embodiment, for example, as illustrated in FIG. 2B, a stage calculation unit 250 includes a stage input acquisition unit 251 and three block calculation units 252, 253, and 254.

The stage input acquisition unit 251 acquires an input to the stage (stage calculation unit 250). The stage input acquisition unit 251 performs, for example, conversion of halving the height and width of the feature amount map by performing convolution with a stride value of 2 on the input feature amount map. For example, the stage input acquisition unit 251 may perform normalization conversion on the input feature amount map. For example, the normalization includes batch normalization described in Batch normalization: Accelerating deep network training by reducing internal covariate shift (S. Ioffe and C. Szegedy, ICML, 2015) and layer normalization described in Layer normalization (Jimmy Lei Ba, Jamie Ryan Kiros, and Geoffrey E Hinton, arXiv preprint arXiv:1607.06450, 2016).

The input feature amount map is a three-dimensional tensor of height, width, and channel, but is converted into a two-dimensional tensor of a spatial direction and a channel direction by integrating dimensions of height and width. Examples of a conversion from the three-dimensional tensor to the two-dimensional tensor include a process of dividing an image into a plurality of local regions, and converting the image into a two-dimensional tensor in which each region has a feature amount in the channel direction. The conversion performed by the stage input acquisition unit 251 is not limited to the conversion described above.

In the block calculation units 252 to 254, each of the block calculation units 252 to 254 processes an output of the stage input acquisition unit 251 or the previous block calculation unit to acquire the feature amount map. For example, the block calculation unit 253 acquires the feature amount map by performing conversion or the like on the feature amount map output from the block calculation unit 252 of the previous stage. Although FIG. 2B illustrates an example in which three block calculation units 252 to 254 are included, the number of block calculation units included in the stage calculation unit 250 may be any number and is not limited to three.

FIG. 2C is a diagram illustrating a configuration example of the block calculation unit illustrated in FIG. 2B. In the present exemplary embodiment, as illustrated in FIG. 2C, a block calculation unit 260 includes a block input acquisition unit 261, a generation unit 262, a transformation unit 263, an output unit 264, and a residual connection unit 265. The block input acquisition unit 261 acquires an input to a block (block calculation unit 260). The generation unit 262 generates an attention map based on input data acquired by the block input acquisition unit 261. The transformation unit 263 generates a feature amount map to which attention is applied by performing non-linear transformation on the input data acquired by the block input acquisition unit 261. Based on the attention map generated by the generation unit 262 and the output of the transformation unit 263, the output unit 264 outputs output data which is a feature amount map having a channel dimension for storing an element vector and one or more spatial dimensions. The residual connection unit 265 combines the input acquired by the block input acquisition unit 261 and the output of the output unit 264 by adding them. The residual connection unit 265 is an example of an addition unit. Note that details of each of the block input acquisition unit 261, the generation unit 262, the transformation unit 263, the output unit 264, and the residual connection unit 265 included in the block calculation unit 260 will be described below in the description of the neural network according to the present exemplary embodiment.

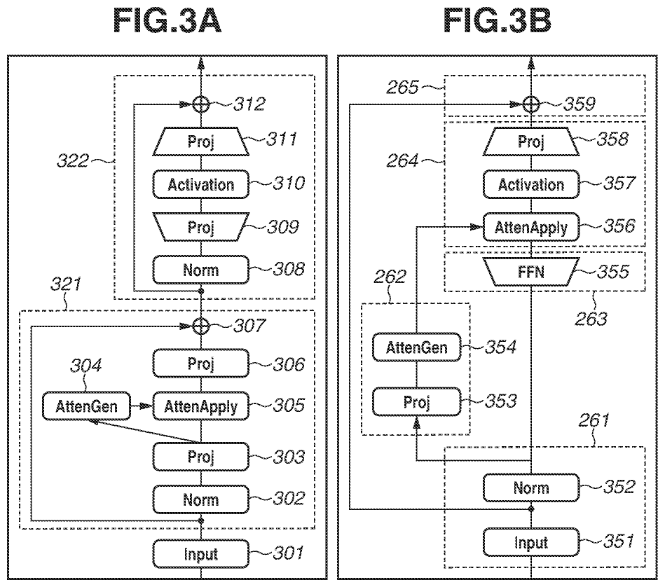

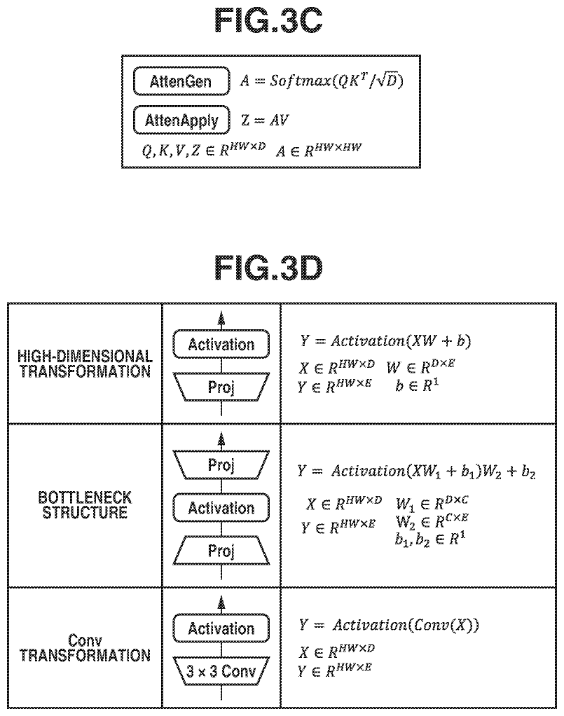

Next, a neural network processed by the block calculation unit according to the first exemplary embodiment will be described. First, the neural network according to the first exemplary embodiment will be described in comparison with a comparative example with reference to FIG. 3. Then, a correspondence between the neural network according to the first exemplary embodiment and the block calculation unit 260 illustrated in FIG. 2C will be described.

FIG. 3A is a diagram schematically illustrating the comparative example of the neural network including an attention mechanism according to the first exemplary embodiment. The processing of the neural network in the comparative example illustrated in FIG. 3A is roughly divided into a first half portion 321 and a second half portion 322. The first half portion 321 is a portion to which self-attention is mainly applied, and the second half portion 322 is a portion to which an activation function is applied after the number of dimensions in the channel direction of the feature amount map is increased.

Here, the number of dimensions in the channel direction of the feature amount map is different from the number of dimensions of the tensor of the feature amount map, and refers to the number of elements constituting each axis of the tensor. The neural network generates a more complicated feature amount from a certain feature amount by a convolution operation or processing of a fully connected layer. At this time, the number of elements of each axis of the feature amount map can be changed before and after a conversion. The number of dimensions includes these two kinds of dimensions.

The first half portion 321 according to the comparative example illustrated in FIG. 3A will be described. First, Norm 302 performs normalization based on Input 301. Next, Proj 303 performs conversion into three feature amount maps called a query (Q), a key (K), and a value (V), which are also described in Japanese Unexamined Patent Application Publication (Translation of PCT Application) No. 2020-506466, by linear transformation. Next, AttenGen 304 generates an attention map from the query (Q) and the key (K). The AttenGen 304 generates an attention map A in accordance with a formula indicated as AttenGen in FIG. 3C.

In the formula, D is the number of dimensions of the query (Q), key (K), and value (V) channels. H is the height of the three-dimensional tensor, and W is the width of the three-dimensional tensor. In other words, HW is the product of the height and width.

AttenApply 305 then applies the generated attention map A to the value (V). The AttenApply 305 outputs an output Z obtained by applying the attention map A to the value (V) by the matrix product of the attention map A and the value (V) as illustrated in FIG. 3C. Next, Proj 306 performs linear transformation, and an adder 307 adds the input to the first half portion 321 and a processing result so far.

Next, the second half portion 322 according to the comparative example illustrated in FIG. 3A will be described. Norm 308 normalizes an input feature amount of the second half portion 322. Next, Proj 309 transforms the feature amount into a feature amount of a high-dimensional channel by linear transformation. Activation 310 applies an activation function to the feature amount. As the activation function, for example, a known activation function such as the rectified linear unit (ReLU), or Gaussian error linear unit (GELU) is used. Proj 311 transforms the dimension of the channel into the same number of dimensions as the input dimension to the second half portion 322 by linear transformation. An adder 312 adds the input to the second half portion 322 and a processing result so far.

Next, issues related to the comparative example illustrated in FIG. 3A will be described. In the comparative example, the AttenGen 304 obtains the degree of similarity between feature amount maps in the spatial direction, and generates an attention map in which a portion having a high degree of similarity has a high value. Then, according to the generated attention map, the AttenApply 305 applies weights to each spatial position of the value (V) by the degree of similarity and aggregates the values. At this time, when many noise components are included in the channels of the feature amount map, the values are aggregated including the noise components, and thus there is a problem in that the noise components tend to be reinforced. Further, in the second half portion 322 after application of attention, processing such as conversion processing into a high-dimensional feature amount and application of an activation function is performed independently of the first half portion 321. Thus, an amount of calculation of the entire processing tends to increase.

In the neural network including the attention mechanism according to the present exemplary embodiment illustrated in FIG. 3B, which will be described below, processing for generating an attention map is performed using a low-dimensional feature amount. Then, the feature amount map is converted to separate and remove the noise components, and then the attention map is applied. As described above, the attention generation and application processing and the feature amount high-dimensional transformation processing, which are independently performed in the comparative example, are integrated in the present exemplary embodiment. As a result, in the present exemplary embodiment, it is possible to improve processing accuracy of the neural network while reducing the number of learning parameters and the amount of calculation compared to the related art.

The neural network provided with the attention mechanism according to the first exemplary embodiment will be described with reference to FIG. 3B. FIG. 3B is a diagram schematically illustrating an example of the neural network according to the first exemplary embodiment. In FIG. 3B, the correspondence with the configuration of the block calculation unit 260 illustrated in FIG. 2C is illustrated using the same reference numerals as those in FIG. 2C.

First, Norm 352 normalizes an input based on Input 351. Next, Proj 353 acquires a query (Q) and a key (K) by linear transformation based on the output of the Norm 352. Next, AttenGen 354 generates an attention map from the query (Q) and the key (K) obtained in the Proj 353. The AttenGen 354 generates the attention map A using the formula indicated as the AttenGen in FIG. 3C, similarly to the AttenGen 304.

While the processing of generating the attention map is performed in this way, a feedforward network (FFN) 355 receives an output of the Norm 352 as an input, and expands the channel dimension and performs nonlinear transformation. The FFN 355 performs the nonlinear transformation using, for example, the high-dimensional transformation illustrated in FIG. 3D. The high-dimensional transformation illustrated in FIG. 3D will be described in detail below.

Then, AttenApply 356 outputs a feature amount based on the attention map A generated in the AttenGen 354 and a value (V′) (nonlinearly transformed value (V)) output from the FFN 355. As in the case of the AttenApply 305, the AttenApply 356 outputs the output Z based on the value (V′) and the attention map A by the matrix product of the attention map A and the value (V′).

Next, Activation 357 applies an activation function to the feature amount (the output Z of AttenApply 356). As the activation function, for example, the known activation function, such as the ReLU, or GELU is used. Proj 358 transforms the dimension of the channel to the same number of dimensions as the Input 351 by linear transformation. An adder 359 adds the Input 351 and a processing result so far.

Next, the correspondence between the neural network according to the first exemplary embodiment illustrated in FIG. 3B and the configuration of the block calculation unit 260 illustrated in FIG. 2C will be described. In the following description, the neural network processed by the block calculation unit is referred to as a block.

The block is a subnetwork of the neural network processed by the network calculation unit 220.

The block input acquisition unit 261 of the block calculation unit 260 corresponds to a portion indicated by reference numeral 261 in FIG. 3B. In the present exemplary embodiment, the block input acquisition unit 261 acquires a feature amount map having a channel dimension for storing an element vector and one or more spatial dimensions as an input to the block. For example, in the case of a three-dimensional tensor of height, width, and channel, the height and the width correspond to the spatial dimensions. In the present exemplary embodiment, since the stage input acquisition unit 251 performs conversion into a two-dimensional tensor in which the height dimension and the width dimension are integrated, the feature amount map acquired by the block input acquisition unit 261 is a low-dimensional feature amount map having one spatial dimension. In addition, a vector of the channel dimension is obtained from each spatial position of the two-dimensional tensor, which is referred to as the element vector.

The block input acquisition unit 261 performs conversion of normalization, such as layer normalization, on the feature amount map input to the block. Although not illustrated in FIG. 3B, the block input acquisition unit 261 may perform a transformation process, such as 1×1 convolution (pointwise-convolution). Further, the block input acquisition unit 261 may output the input without performing any conversion. The conversion performed by the block input acquisition unit 261 is not limited thereto.

The generation unit 262 of the block calculation unit 260 corresponds to a portion indicated by reference numeral 262 in FIG. 3B. In the present exemplary embodiment, the generation unit 262 obtains a query (Q) and a key (K) from the input data of the block by linear transformation, and generates an attention map indicating a degree of similarity between spatial dimensions of the query (Q) and the key (K) by an inner product thereof. The query (Q) is an example of first data, and the key (K) is an example of second data.

The attention map is not limited to the degree of similarity between the spatial dimensions, and may be a degree of relationship indicating a relationship between the spatial dimensions. For example, an attention map A∈R^{HW×HW} is obtained from an input X∈R^{HW×D} by using an activation function, such as A=Activation (XW₁+b₁)W₂+b₂. Here, a weight W₁∈R^{D×D} and a weight W₂∈R^{D×HW}, and biases b₁. b₂∈R¹. Activation is the activation function. Thus, the attention map is not obtained from the degree of similarity between the spatial dimensions of the input X, but the attention map can be obtained by estimating the degree of relationship between the spatial dimensions. As described above, the method of generating the attention map according to the present exemplary embodiment is not limited to one form.

The transformation unit 263 of the block calculation unit 260 corresponds to a portion indicated by reference numeral 263 in FIG. 3B. The transformation unit 263 receives an output of the block input acquisition unit 261 as an input, expands the channel dimension, performs nonlinear transformation, and outputs a result. The output of the transformation unit 263 is an example of third data. As processing of the transformation unit 263, several types of processing illustrated in FIG. 3D can be applied.

For example, as illustrated in “high-dimensional transformation”, after the number of channel dimensions is transformed to a high dimension by linear transformation (Proj), an activation function is applied (Activation). Here, X is an input of the FFN, and Y is an output of the FFN. W is a weight of the linear transformation, and b is a bias of the linear transformation. D is the number of channel dimensions of the input, and E is the number of channel dimensions after the transformation.

Thus, E takes a value larger than D. Activation is an activation function such as ReLU. This makes it possible to increase the separability of the noise components in the channel dimension of the feature amount map.

Further, for example, as illustrated in “bottleneck structure”, after the channel dimension is transformed to a low dimension by linear transformation (Proj), an activation function is applied (Activation), and then the dimension is extended to a high dimension by linear transformation (Proj). Here, the weight W₁ and the bias b₁ are linear transformation parameters to a lower dimension, and the weight W₂ and the bias b₂ are linear transformation parameters to a higher dimension. D. C, and E are the numbers of channel dimensions, and C is smaller than D, and E is larger than D. Note that E may take the same value as D, in which case there need not be the Proj 358 that transforms the channel dimension back to the channel dimension of the block input. The bottleneck structure has effects of dropping unnecessary information and increasing the separability of the noise components of the feature amount. Thus, in order to increase the separability of the noise components of the feature amount, it is not always necessary to transform the channel dimension to a high-dimensional value.

In the above-described high-dimensional transformation and bottleneck structure, transformation is performed independently for each element vector. However, for example, as illustrated in “Conv transformation”, the channel dimension may be expanded to a high dimension by using convolution and by using a plurality of element vectors. When convolution is applied, the feature amount map is returned to the three-dimensional tensor of height, width, and channel, and then the spatial directions of height and width are convoluted. Here, for example, convolution with a kernel size of 3×3 is performed, and convolution for expanding the number of channel dimensions of outputs to E is applied (3×3 Conv and Activation). Note that the processing of the transformation unit 263 is not limited to these, and may be other non-linear transformation processing.

The output unit 264 of the block calculation unit 260 corresponds to a portion indicated by reference numeral 264 in FIG. 3B. The output unit 264 outputs output data, which is a feature amount map having a channel dimension for storing an element vector and one or more spatial dimensions, based on the attention map generated by the generation unit 262 and the output (third data) of the transformation unit 263. In the present exemplary embodiment, for each spatial position of the third data, the output unit 264 weights and aggregates the element vectors of the spatial positions in a surrounding area of the third data by the degree of similarity (degree of relationship) indicated by the attention map described above. Note that in the present exemplary embodiment, the surrounding area refers to all spatial positions, but the way of setting the surrounding area is not limited thereto.

In the present exemplary embodiment, as indicated by the Proj 358, the output unit 264 transforms the number of channel dimensions of the feature amount map to which attention has been applied to the same number of channel dimensions as that of the Input 351. However, when the transformation unit 263 does not extend the channel dimension, the process of returning the number of channel dimensions as indicated by the Proj 358 may be omitted. Further, in the example illustrated in FIG. 3B, there is the Activation 357 in which the activation function is applied to the feature amount, but this process may be omitted. Alternatively, an additional process not illustrated in FIG. 3B may be performed. The processing performed by the output unit 264 is not limited to these.

The residual connection unit 265 of the block calculation unit 260 corresponds to a portion indicated by reference numeral 265 in FIG. 3B. The residual connection unit 265 combines and outputs the input of the block input acquisition unit 261 and the output of the output unit 264 by adding them.

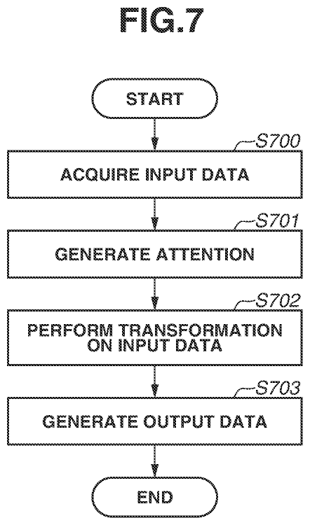

The main part of the processing performed by the information processing apparatus according to the present exemplary embodiment will be described with reference to the flowchart of FIG. 7. Note that a prefix S used in each of the following flowcharts represents a processing step. In step S700, the block input acquisition unit 261 inputs input data, which is the feature amount map, to the neural network having the attention mechanism. The input data (feature amount map) is obtained by converting image data of an image that includes a person, which is obtained by the image acquisition unit 210, by other processing blocks up to the block input acquisition unit 261. In the present exemplary embodiment, the feature amount map is described as being obtained by processing image data of an image that includes a person. However, other types of data may be used. More specifically, the input data may be a feature amount map obtained by converting any of image data, video data (a combination of images and audio), audio data, and natural language data. In step S701, the generation unit 262 obtains the query (Q) and the key (K) from the input data of the block by linear transformation, and generates attention indicating the degree of similarity between the spatial dimensions of the query (Q) and the key (K) by the inner product thereof. In step S702, the transformation unit 263 generates an intermediate feature amount map to which attention is applied by performing nonlinear transformation on the input data. In step S703, the output unit 264 outputs output data, which is a feature amount map having a channel dimension for storing an element vector and one or more spatial dimensions, based on the generated attention map and the output of the transformation unit 263.

According to the present exemplary embodiment, attention processing is not directly performed on the feature amount used to generate the attention, but the attention processing is performed after non-linear transformation is performed on the feature amount. In this way, by applying the attention map after reducing the noise components of the feature amount, emphasis on unnecessary features is suppressed. Thus, the effect of attention is enhanced, and the processing accuracy of the neural network can be improved. In addition, by integrating the processes of the first half portion and the second half portion illustrated in the comparative example, the learning parameter and the calculation amount are reduced, and it is possible to improve the efficiency of the processing in the neural network.

The attention described in the present exemplary embodiment may have a multi-head configuration as described in Japanese Unexamined Patent Application Publication (Translation of PCT Application) No. 2020-506466.

In the first exemplary embodiment described above, the attention map indicates the relationship (the degree of similarity or the degree of relationship) between the spatial positions by the shape of R^{HW×HW}. However, the attention map does not necessarily have to have this shape. In a second exemplary embodiment described below, an example of generating and applying an attention map having a different shape through application to local attention described in Learned Queries for Efficient Local Attention (Moab Arar et al, CVPR2022) will be described.

Therein, attention is applied by using a learning type query in a sliding window. Specifically, an attention map is generated from the learning type query and a feature amount map in the window, and an output value at the center of the window is determined by calculating a weighted sum of feature amounts in the window according to the attention map. By sliding the window, the entire feature amount map is processed.

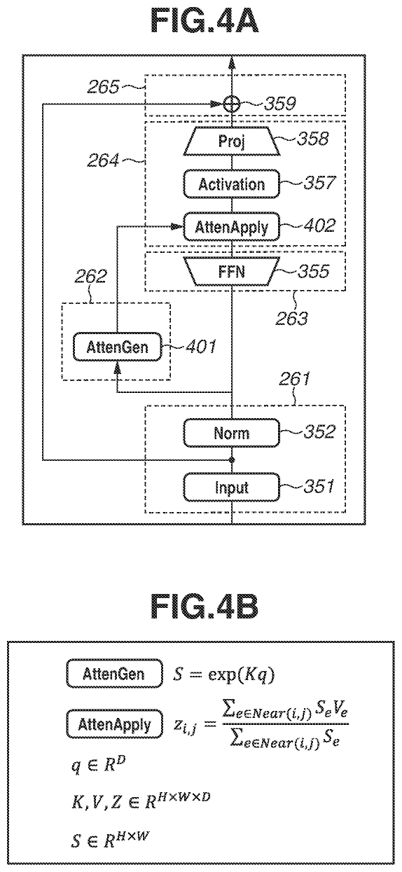

A neural network processed by a block calculation unit according to the second exemplary embodiment will be described. FIG. 4A is a diagram schematically illustrating an example of a neural network including an attention mechanism according to the second exemplary embodiment. In FIG. 4A, components having the same functions as those of the components illustrated in FIG. 3B are denoted by the same reference numerals, and redundant description thereof will be omitted. The neural network illustrated in FIG. 4A is different from the neural network according to the first exemplary embodiment illustrated in FIG. 3B in that there is no Proj 353 and that AttenGen 401 and AttenApply 402 are provided. Also, in the second exemplary embodiment, the Input 351 is provided as a three-dimensional tensor of height, width, and channels. In other words, in the first exemplary embodiment, the stage input acquisition unit 251 integrates the height and the width dimensions, but in the second exemplary embodiment, the integration is not performed.

The AttenGen 401 generates an attention map S by applying a learning parameter q to an input key (K) in accordance with a formula indicated as AttenGen illustrated in FIG. 4B.

The AttenApply 402 obtains an output Z in accordance with the formula indicated as AttenApply illustrated in FIG. 4B. Here, Z_{i, j} is an element vector of the position (i, j) of Z. Near (i, j) is a set of neighboring positions within the sliding window of the position (i, j). “e” corresponds to one of neighboring positions which are elements of the set Near (i, j). Sₑ is an element vector of S (attention map) corresponding to the neighboring position e, and Vₑ is an element vector of V (value) corresponding to the neighboring position e.

Next, the correspondence between the neural network according to the second exemplary embodiment illustrated in FIG. 4A and the configuration of the block calculation unit 260 illustrated in FIG. 2C, and a difference from the first exemplary embodiment will be described.

The block input acquisition unit 261 of the block calculation unit 260 corresponds to a portion indicated by reference numeral 261 in FIG. 4A. In the present exemplary embodiment, the block input acquisition unit 261 acquires a feature amount map having a channel dimension for storing an element vector and one or more spatial dimensions as an input to the block. In the present exemplary embodiment, since the block input acquisition unit 261 performs processing using a three-dimensional tensor of height, width, and channel as an input, the height and the width correspond to the spatial dimensions.

The generation unit 262 of the block calculation unit 260 corresponds to a portion indicated by reference numeral 262 in FIG. 4A. In the present exemplary embodiment, the generation unit 262 generates the attention indicating the degree of relationship between the spatial dimensions by the inner product of the learning parameter (first data) q and the input (second data). Note that in the example illustrated in FIG. 4B, the shape of the learning parameter q is R^{D}, but this can be interpreted as indicating that the attention map indicates the degree of relationship between the spatial dimensions if it is interpreted that the length of the spatial dimension is being omitted because the length is 1. Further, in the present exemplary embodiment, the input is directly obtained as the second data, but the second data may be obtained by subjecting the input to linear transformation or the like. The method of acquiring the second data is not limited thereto.

The transformation unit 263 of the block calculation unit 260 corresponds to a portion indicated by reference numeral 263 in FIG. 4A. The transformation unit 263 is the same as that in the first exemplary embodiment.

The output unit 264 of the block calculation unit 260 corresponds to a portion indicated by reference numeral 264 in FIG. 4A. The output unit 264 outputs output data, which is a feature amount map having a channel dimension for storing an element vector and one or more spatial dimensions, based on the attention map generated by the generation unit 262 and the output (third data) of the transformation unit 263. For each spatial position of the third data, the output unit 264 weights and aggregates the element vectors of the spatial positions in a surrounding area of the third data by the degree of relationship indicated by the attention map described above. While the surrounding area refers to the entire area (all spatial positions) in the first exemplary embodiment, it is the range of the window in the second exemplary embodiment.

The residual connection unit 265 of the block calculation unit 260 corresponds to a portion indicated by reference numeral 265 in FIG. 4A. The residual connection unit 265 is the same as that of the first exemplary embodiment.

As described above, in the second exemplary embodiment, the attention map S has the shape of R^{HW}, which is different from R^{HW×HW} of the attention map in the first exemplary embodiment. Even when the attention map has a different shape as described above, the attention map can be generated and applied in the same manner as in the first exemplary embodiment, and the processing accuracy of the neural network can be improved. In addition, the efficiency of processing in the neural network can be improved.

In the second exemplary embodiment, the dimension of the input at the time of generating the attention is equivalent to the input dimension of the neural network (block calculation unit 260). More specifically, in the neural network illustrated in FIG. 4A, the input of the AttenGen 401 is the same as the channel dimension of the feature amount map of the Input 351. In a third exemplary embodiment to be described below, a feature amount map converted into a feature amount map with a channel dimension smaller than the channel dimension of the feature amount map of the Input 351 is input to the AttenGen 401, and the generation of the attention is executed with a low dimension.

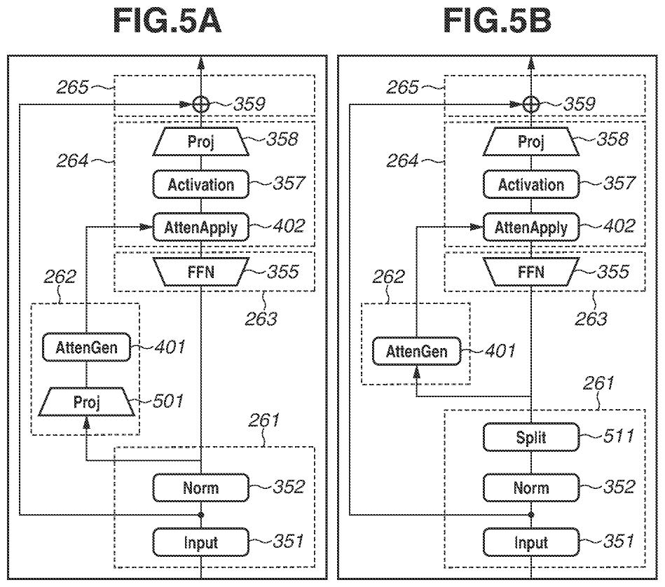

The neural network processed by a block calculation unit according to the third exemplary embodiment will be described. FIG. 5A is a diagram schematically illustrating an example of a neural network including an attention mechanism according to the third exemplary embodiment. In FIG. 5A, components having the same functions as those of the components illustrated in FIGS. 3B and 4A are indicated by the same reference numerals, and redundant description thereof will be omitted.

In the neural network illustrated in FIG. 5A, with regard to data to be input to the AttenGen 401, the channel dimension of the feature amount map is transformed to a lower dimension than the input by Proj 501 in advance. The Proj 501 transforms the normalized Input 351 to a lower dimension such as by a linear transformation. For example, the Proj 501 uses an input X∈R^{H×W×D}, a weight W∈R^{D×C}, and a bias b∈R¹ and outputs X′∈R^{H×W×C} transformed to a lower dimension as X′=XW+b or the like. Here, the number of dimensions C is smaller than the number of dimensions D. Note that transformation processing by the Proj 501 to a low dimension is performed by the generation unit 262 of the block calculation unit 260.

FIG. 5B is a diagram schematically illustrating another example of the neural network including the attention mechanism according to the third exemplary embodiment. In FIG. 5B, components having the same functions as those of the components illustrated in FIGS. 3B and 4A are indicated by the same reference numerals, and redundant description thereof will be omitted. In the neural network illustrated in FIG. 5B, transformation to a lower dimension is performed by a method different from that of the neural network illustrated in FIG. 5A.

In the neural network illustrated in FIG. 5B, Split 511 divides an output of the Norm 352 into two in a channel dimension direction. More specifically, the Split 511 divides the input X∈R^{H×W×D} into two of X₁, X₂∈R^{H×W×D/2}, passes X₁ to the AttenGen 401, and passes X₂ to the FFN 355. Note that transformation processing by the Split 511 to a low dimension is performed by the block input acquisition unit 261 of the block calculation unit 260.

Although FIGS. 5A and 5B illustrate an example in which the present disclosure is applied to the neural network according to the second exemplary embodiment using the local attention illustrated in FIG. 4A, the present disclosure can also be applied to the neural network according to the first exemplary embodiment illustrated in FIG. 3B. In the case of application to the neural network according to the first exemplary embodiment illustrated in FIG. 3B, linear conversion for generating a key (K) and a query (Q) may be inserted immediately before the AttenGen 354.

In the third exemplary embodiment, an attention is generated using low dimensional data. Since the attention is obtained by calculating the degree of similarity in the spatial direction from the inner product of the elements, the accuracy is less likely to be degraded even when the attention is generated by a low-dimensional calculation. On the other hand, since the calculation of the inner product is performed with a low dimension, the number of product-sum calculations is reduced, and the calculation efficiency can be increased.

In the above-described exemplary embodiments, self-attention as described in Document A has been described as an example. In a fourth exemplary embodiment, application to a mechanism for generating an attention map from input data and performing attention based on an element product of the input data and the attention map as described in Document B will be described.

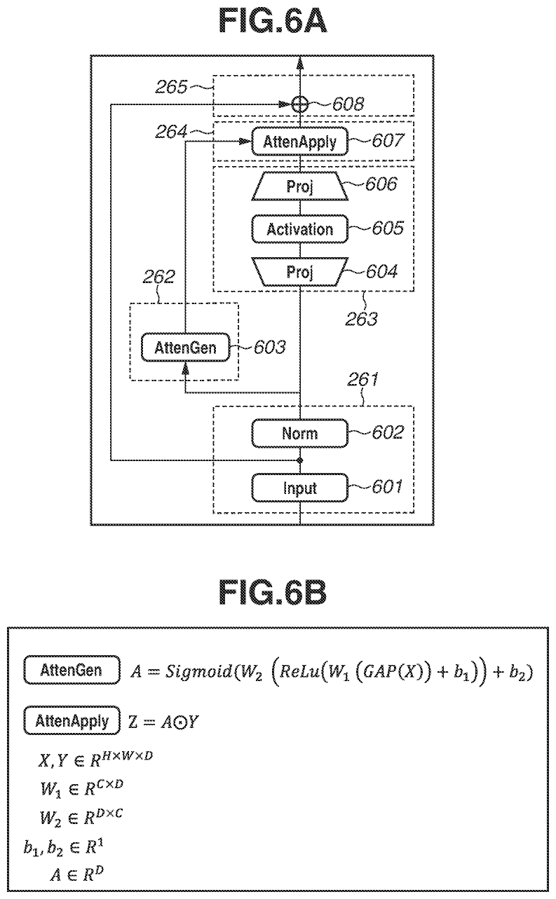

The neural network processed by a block calculation unit according to the fourth exemplary embodiment will be described. FIG. 6A is a diagram schematically illustrating an example of a neural network including an attention mechanism according to the fourth exemplary embodiment. In the first exemplary embodiment described above, the stage input acquisition unit 251 illustrated in FIG. 2B converts the three-dimensional tensor of height, width, and channel of the input feature amount map into a two-dimensional tensor by integrating the height and width dimensions. However, in the fourth exemplary embodiment, the conversion from the three-dimensional tensor to the two-dimensional tensor is not performed, and the state of the three-dimensional tensor of height, width, and channel is maintained.

Input 601 is given a three-dimensional tensor as an input feature amount map. Then, Norm 602 performs a normalizing process, such as a layer normalization or a batch normalization on the input. AttenGen 603 generates an attention map in accordance with a formula indicated as AttenGen illustrated in FIG. 6B using an output of the Norm 602 as an input. Here, X is the input to the AttenGen 603. GAP is GlobalAveragePooling for obtaining an average in the dimension of the spatial direction of the height and the width, in other words, averaging the feature amount map for each channel. W₁, W₂ are weights of the linear transformation, and b₁, b₂ are biases of the linear transformation. ReLu and Sigmoid are activation functions. D and C are the numbers of channel dimensions, and C is set to a value smaller than D.

Proj 604 uses an output of the Norm 602 as an input, and expands the channel dimension to a higher dimension by linear transformation. Activation 605 applies an activation function to the feature amount (output of the Proj 604). As the activation function, for example, a known activation function such as ReLU, or GELU, is used. Proj 606 transforms the channel dimension to the same number of dimensions as the channel dimension of the input of the Proj 604 by linear transformation.

AttenApply 607 outputs a feature amount based on the generated attention map and the output of the Proj 606 in accordance with a formula indicated as AttenApply illustrated in FIG. 6B.

Here, A is the attention map that is the output of the AttenGen 603. Y is a feature amount map of the output of the Proj 606. The AttenApply 607 calculates the product of both elements. Note that A∈R^{D}, Y∈R^{H×W×D}, and while the attention map A and the output Y of the Proj 606 are different in shape, the AttenApply 607 calculates the product of both elements by compensating for an insufficient dimension by copying using a method known as broadcast or the like. An adder 608 adds the Input 601 and a processing result so far.

Next, the correspondence between the neural network according to the fourth exemplary embodiment illustrated in FIG. 6A and the configuration of the block calculation unit 260 illustrated in FIG. 2C, and a difference from the first exemplary embodiment will be described.

The block input acquisition unit 261 of the block calculation unit 260 corresponds to a portion indicated by reference numeral 261 in FIG. 6A. In the present exemplary embodiment, the block input acquisition unit 261 acquires a feature amount map having a channel dimension for storing an element vector and one or more spatial dimensions as an input to the block. In the present exemplary embodiment, since the block input acquisition unit 261 performs processing using a three-dimensional tensor of height, width, and channel as an input, the height and the width correspond to the spatial dimensions.

The generation unit 262 of the block calculation unit 260 corresponds to a portion indicated by reference numeral 262 in FIG. 6A. In the present exemplary embodiment, the generation unit 262 generates an attention map by calculating a weight in accordance with one or more dimensions from the output of the block input acquisition unit 261. In the present exemplary embodiment, the attention A∈R^{D} is obtained by the formula indicated as AttenGen illustrated in FIG. 6B, and the attention map in accordance with the channel dimension is obtained. However, an attention map in accordance with A∈R^{H×W} and the height and width dimensions may be obtained, for example, by deleting the channel dimension direction of the input X with the GlobalAveragePooling or the like. Alternatively, an attention map in accordance with A∈R^{H×W×D} and three dimensions may be obtained. For example, convolution or the like may be applied to the input X to obtain a feature amount map having the same size as the input. The shape and the acquisition method of the attention map are not limited thereto.

The transformation unit 263 of the block calculation unit 260 corresponds to a portion indicated by reference numeral 263 in FIG. 6A. In the present exemplary embodiment, the transformation unit 263 generates a feature amount map to which attention is applied by performing nonlinear transformation on an input. Note that the bottleneck structure illustrated in FIG. 3D may be used as D=E, and the conversion method is not limited thereto.

The output unit 264 of the block calculation unit 260 corresponds to a portion indicated by reference numeral 264 in FIG. 6A. In the present exemplary embodiment, the output unit 264 calculates the product of the output of the transformation unit 263 and the attention map generated by the generation unit 262.

The residual connection unit 265 of the block calculation unit 260 corresponds to a portion indicated by reference numeral 265 in FIG. 6A. The residual connection unit 265 is the same as that according to the first exemplary embodiment.

As described above, in the fourth exemplary embodiment, application to the mechanism for performing attention by the product of elements of the input data and the attention map has been described. In a conventional method, application of the attention (the AttenApply 607) is performed immediately before the Proj 604 illustrated in FIG. 6A. In other words, after the attention is applied, the transformation by the transformation unit 263 is applied. In the conventional method, since the strength of the feature amount is varied for each channel unit, when an unnecessary feature is partially included in the input feature amount, the unnecessary feature may also be emphasized. On the other hand, by applying the attention after applying the transformation by the transformation unit 263 as in the present exemplary embodiment, it is possible to reduce unnecessary information components by the Activation 605 included in the transformation unit 263 and then add the strength to the feature amount. In this method, since an unnecessary component of the feature amount is rarely emphasized, the performance of the neural network can be further improved. According to exemplary embodiments of the present disclosure, it is possible to improve the processing accuracy of a neural network including an attention mechanism.

Note that each of the above-described exemplary embodiments is merely an example for embodying the present disclosure, and the technical scope of the present disclosure should not be interpreted in a limited manner by these exemplary embodiments. In other words, the present disclosure can be implemented in various forms without departing from the technical idea or the main features thereof.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-184280, filed Nov. 17, 2022, which is hereby incorporated by reference herein in its entirety.

What is claimed is:

1. An information processing apparatus performing inference or learning using a neural network, the information processing apparatus comprising:
one or more processors; and
one or more memories that store a computer-readable instruction that, when executed by the one or more processors, configures the information processing apparatus to:
generate an attention map from input data;
perform a nonlinear transformation on the input data;
obtain, based on the generated attention map and an output obtained based on the nonlinear transformation on the input data, a feature amount map having a channel dimension for storing an element vector and one or more spatial dimensions; and
perform an inference or learning process based on the obtained feature amount map.

2. The information processing apparatus according to claim 1, wherein the input data is a feature amount map having a channel dimension for storing an element vector and one or more spatial dimensions.

3. The information processing apparatus according to claim 2,
wherein the attention map indicates a relationship between spatial dimensions of first data and second data obtained from the input data,
wherein the input data is transformed to third data by nonlinear transformation, and
wherein the feature amount map is generated by calculating, for each spatial position of the third data, an element vector of a spatial position in a surrounding area of the third data based on weighting determined based on the attention map.

4. The information processing apparatus according to claim 2,
wherein the attention map indicates a relationship between spatial dimensions of first data obtained from learning parameters and second data obtained from the input data,
wherein the input data is converted into third data by nonlinear transformation, and
wherein the feature amount map is generated by calculating, for each spatial position of the third data, an element vector of a spatial position in a surrounding area of the third data based on weighting determined based on the attention map.

5. The information processing apparatus according to claim 2,
wherein the attention map indicates a relationship between spatial dimensions of the input data,
wherein the input data is transformed to third data by nonlinear transformation, and
wherein the feature amount map is generated by calculating, for each spatial position of the third data, an element vector of a spatial position in a surrounding area of the third data based on weighting determined based on the attention map.

6. The information processing apparatus according to claim 3,
wherein data used to generate the attention map is acquired based on data obtained by dividing the input data in a channel dimension direction, and
wherein the third data is acquired based on data obtained by dividing the input data in the channel dimension direction.

7. The information processing apparatus according to claim 2,
wherein the attention map is generated by calculating a weight in accordance with one or more dimensions from the input data, and
wherein the feature amount map is calculated by a product of elements of the attention map and a result of the nonlinear transformation.

8. The information processing apparatus according to claim 1,
wherein the input data and the obtained feature amount map are added to obtain output data, and
wherein the inference or learning process is performed based on the output data.

9. The information processing apparatus according to claim 1, wherein the input data is transformed into high-dimensional data.

10. The information processing apparatus according to claim 1, wherein the input data is converted for each element vector.

11. The information processing apparatus according to claim 8, wherein the output data is obtained by applying attention to an output obtained based on the nonlinear transformation and then transforming the output to a same dimension as the input data.

12. The information processing apparatus according to claim 1,
wherein the input data is transformed to a lower dimension, and
wherein the attention map is generated from the low-dimensional input data.

13. An information processing method executed by an information processing apparatus performing inference or learning using a neural network, the method comprising:
generating an attention map from input data;
performing a nonlinear transformation on the input data;
obtaining, based on the generated attention map and an output obtained based on the nonlinear transformation on the input data, a feature amount map having a channel dimension for storing an element vector and one or more spatial dimensions; and
performing an inference or learning process based on the obtained feature amount map.

14. A non-transitory computer-readable storage medium storing a program for causing a computer of an information processing apparatus performing inference or learning using a neural network to execute a method, comprising:
generating an attention map from input data;
performing a nonlinear transformation on the input data;
obtaining, based on the generated attention map and an output obtained based on the nonlinear transformation on the input data, a feature amount map having a channel dimension for storing an element vector and one or more spatial dimensions; and
performing an inference or learning process based on the obtained feature amount map.
